(19) United States
(12) Patent Application Publication
(10) Pub. No.: US 2013/0314507 A1
(43) Pub. Date: Nov. 28, 2013

(54) IMAGE CAPTURING DEVICE AND DATA PROCESSING METHOD

(71) Applicant: Yoshitomo Akagi, Osaka-shi (JP)

(72) Inventor: Yoshitomo Akagi, Osaka-shi (JP)

(73) Assignee: SHARP KABUSHIKI KAISHA, Osaka-shi, Osaka (JP)

(21) Appl. No.: 13/982,701

(22) PCT Filed: Jan. 27, 2012
(86) PCT No.: PCT/JP2012/051770

§ 371 Date: Jul. 30, 2013

(30) Foreign Application Priority Data
Feb. 1, 2011 (JP) 2011-019683

(51) Int. Cl. H04N 13/02

(52) U.S. Cl. CPC H04N 13/0239
USPC 348/46

(57) ABSTRACT

A mobile phone includes: a first image capturing element for generating left-eye image data; a second image capturing element for generating right-eye image data; a CPU; and a RAM. The CPU determines whether or not the left-eye image data includes an image of an obstacle, such as a finger, that blocks entrance of external light into the first image capturing element, and determines whether or not the right-eye image data includes an image of an obstacle that blocks entrance of external light into the second image capturing element. When one of the left-eye image data and the right-eye image data includes the image of the obstacle and the other of the left-eye image data and the right-eye image data does not include the image of the obstacle, the CPU deletes the one of the left-eye image data and the right-eye image data from the RAM.

### TECHNICAL FIELD

The present invention relates to an image capturing device, a data processing method, and a program. In particular, the present invention relates to an image capturing device of a compound eye type for generating stereoscopic image data, a data processing method in the image capturing device, and a program for controlling the image capturing device.

### BACKGROUND ART

Conventionally, an image capturing device of a compound eye type has been known which generates stereoscopic image data for displaying a stereoscopic image, based on left-eye image data and right-eye image data obtained through image capturing.

Japanese Patent Laying-Open No. 2008-141514 (Patent Document 1) discloses a compound eye digital camera as the image capturing device of a compound eye type. This compound eye digital camera includes: a plurality of image capturing means; detecting means for detecting whether or not image capturing is performed in a portrait manner; recording means for recording, onto a recording medium, images obtained from a part or whole of the plurality of image capturing means; a shutter button for instructing image capturing; and control means for controlling the recording means to record, onto the recording medium, images obtained from a part of the plurality of image capturing means when the detecting means detects that the image capturing is performed in the portrait manner and the image capturing is instructed via the shutter button.

Japanese Patent Laying-Open No. 2010-288253 (Patent Document 2) discloses a compound eye camera as the image capturing device of a compound eye type. The compound eye camera determines whether or not an obstacle is included in an angle of view of viewpoint images obtained by two image capturing units. Specifically, the compound eye camera determines whether or not an obstacle is included in a region falling within a predetermined range of surroundings of the viewpoint images. When the compound eye camera determines that an obstacle is included, the compound eye camera modifies the viewpoint images obtained by the two image capturing units, so as to enable stereoscopic vision of the obstacle region including the obstacle. Further, the compound eye camera performs a three-dimensional process using the modified viewpoint images so as to generate an image for stereoscopic display.

### CITATION LIST

### Patent Document

PTD 1: Japanese Patent Laying-Open No. 2008-141514
PTD 2: Japanese Patent Laying-Open No. 2010-288253

### SUMMARY OF INVENTION

### Technical Problem

However, when performing image capturing in the portrait manner in the compound eye digital camera of Patent Document 1, only an image obtained from a predetermined one of the plurality of image capturing means is recorded onto the recording medium. Hence, when an object, such as the user's finger or a strap of the compound eye digital camera, is over the lens of the predetermined image capturing means, the user can only obtain an image having the object captured therein.

Meanwhile, in the case where image capturing is performed in a landscape manner, for example, even when the object is over the lens of one image capturing means, left-eye image data and right-eye image data as well as stereoscopic image data generated based on the left-eye image data and the right-eye image data are recorded onto the recording medium.

Thus, such image data less valuable for the user are recorded onto the recording medium. Existence of such image data results in reduced storage capacity in the recording medium.

Meanwhile, in the compound eye camera of Patent Document 2, a missing portion of an image of a target due to the obstacle is repaired using another image of the target. Accordingly, in the compound eye camera, image data considered as being unsatisfactory for the user can be prevented from being stored in the recording medium. However, it takes time for the compound eye camera to perform data processes because the following data processes are necessary: a data process for determining whether or not the obstacle is included; and a data process for modifying at least one of the viewpoint images obtained by the two image capturing units.

The invention of the present application has been made in view of the foregoing problem, and has its object to provide an image capturing device, a data processing method, and a program, by each of which a memory can be effectively utilized in a configuration in which a missing portion of an image of a target due to an obstacle is not repaired using another image of the target.

### Solution to Problem

According to an aspect of the present invention, an image capturing device is an image capturing device of a compound eye type for generating stereoscopic image data for displaying a stereoscopic image, based on left-eye image data and right-eye image data obtained through image capturing. The image capturing device includes: a first image capturing element for generating the left-eye image data; a second image capturing element for generating the right-eye image data; a processor; and a memory for storing the left-eye image data, the right-eye image data, and the stereoscopic image data therein. The processor determines whether or not the left-eye image data includes an image of an object that blocks entrance of external light into the first image capturing element. The processor determines whether or not the right-eye image data includes an image of an object that blocks entrance of external light into the second image capturing element. When one of the left-eye image data and the right-eye image data includes the image of the object and the other of the left-eye image data and the right-eye image data does not include the image of the object, the processor deletes the one of the left-eye image data and the right-eye image data from the memory.

Preferably, when the processor deletes the one of the left-eye image data and the right-eye image data from the memory, the processor further deletes, from the memory, the stereoscopic image data generated based on the left-eye image data and the right-eye image data.

Preferably, the image capturing device further includes: a shutter button; and a mechanical shutter, which is operated in response to pressing down of the shutter button. The processor determines whether or not each of the left-eye image data and the right-eye image data obtained through the image capturing employing the mechanical shutter includes the image of the object. When the processor determines that the image of the object is included only in the left-eye image data obtained through the image capturing employing the mechanical shutter, the processor deletes the left-eye image data from the memory. When the processor determines that the image of the object is included only in the right-eye image data obtained through the image capturing employing the mechanical shutter, the processor deletes the right-eye image data from the memory.

Preferably, the image capturing device further includes: a display; an electronic shutter for displaying a live view image on the display; a shutter button; and a mechanical shutter, which is operated in response to pressing down of the shutter button. The processor determines whether or not each of the left-eye image data and the right-eye image data obtained through the image capturing employing the electronic shutter includes the image of the object. When the shutter button is pressed down in a case where the processor determines that the image of the object is included only in the left-eye image data obtained through the image capturing employing the electronic shutter, the processor deletes, from the memory, the left-eye image data obtained through the image capturing employing the mechanical shutter. When the shutter button is pressed down in a case where the processor determines that the image of the object is included only in the right-eye image data obtained through the image capturing employing the electronic shutter, the processor deletes, from the memory, the right-eye image data obtained through the image capturing employing the mechanical shutter.

Preferably, the image capturing device has an automatic focusing function. The processor determines whether or not the image of the object is included in each of the left-eye image data and the right-eye image data obtained through the image capturing employing the electronic shutter with focus being attained by the automatic focusing function, using the left-eye image data and the right-eye image data.

Preferably, the memory includes a volatile memory and a nonvolatile memory. The processor stores the left-eye image data and the right-eye image data in the volatile memory. When the processor determines that one of the left-eye image data and the right-eye image data includes the image of the object and the other of the left-eye image data and the right-eye image data does not include the image of the object, the processor deletes the one of the left-eye image data and the right-eye image data from the volatile memory, and stores the other of the left-eye image data and the right-eye image data in the nonvolatile memory.

Preferably, the nonvolatile memory is a recording medium attachable/detachable to/from the image capturing device.

According to another aspect of the present invention, a data processing method is a data processing method in an image capturing device of a compound eye type for generating stereoscopic image data for displaying a stereoscopic image, based on left-eye image data and right-eye image data obtained through image capturing. The image capturing device includes a first image capturing element for generating the left-eye image data, a second image capturing element for generating the right-eye image data, a processor, and a memory for storing the left-eye image data, the right-eye image data, and the stereoscopic image data therein. The data processing method includes the steps of: determining, by the processor, whether or not the left-eye image data includes an image of an object that blocks entrance of external light into the first image capturing element; determining, by the processor, whether or not the right-eye image data includes an image of an object that blocks entrance of external light into the second image capturing element; and when one of the left-eye image data and the right-eye image data includes the image of the object and the other of the left-eye image data and the right-eye image data does not include the image of the object, the processor deleting the one of the left-eye image data and the right-eye image data from the memory.

According to still another aspect of the present invention, a program is a program for controlling an image capturing device of a compound eye type for generating stereoscopic image data for displaying a stereoscopic image, based on left-eye image data and right-eye image data obtained through image capturing. The image capturing device includes a first image capturing element for generating the left-eye image data, a second image capturing element for generating the right-eye image data, a processor, and a memory for storing the left-eye image data, the right-eye image data, and the stereoscopic image data therein. The program causes the processor to perform the steps of: determining whether or not the left-eye image data includes an image of an object that blocks entrance of external light into the first image capturing element; determining whether or not the right-eye image data includes an image of an object that blocks entrance of external light into the second image capturing element; and when one of the left-eye image data and the right-eye image data includes the image of the object and the other of the left-eye image data and the right-eye image data does not include the image of the object, deleting the one of the left-eye image data and the right-eye image data from the memory.

### Advantageous Effects of Invention

According to the present invention, a memory can be effectively utilized in a configuration in which a missing portion of an image of a target due to an obstacle is not repaired using another image of the target.

### BRIEF DESCRIPTION OF DRAWINGS

FIG. 1 shows an external appearance of a mobile phone.

FIG. 2 illustrates a first example of data processes performed by the mobile phone when capturing images of a target using two cameras.

FIG. 3 illustrates a second example of data processes performed by the mobile phone when capturing images of a target using the two cameras.

FIG. 4 illustrates a third example of data processes performed by the mobile phone when capturing images of a target using the two cameras.

FIG. 5 shows a hardware configuration of the mobile phone.

FIG. 6 shows main portions of the hardware configuration of the mobile phone.

FIG. 7 is a flowchart showing a flow of processes performed in the mobile phone.

FIG. 8 is a flowchart showing a detail of a process in a step S28 of FIG. 7.

FIG. 9 is a flowchart showing another flow of the processes performed in the mobile phone.

### DESCRIPTION OF EMBODIMENTS

The following describes an image capturing device according to an embodiment of the present invention with reference to figures. In the description below, the same components are given the same reference characters. Their names and functions are also the same. Hence, they are not repeatedly described in detail.

Examples of the image capturing device include: digital single-lens reflex cameras; compact digital cameras; mobile phones inclusive of smart phones; PDAs (Personal Digital Assistant); and the like. In the description below, a mobile phone is exemplified and illustrated as the image capturing device.

<External Appearance of Mobile Phone>

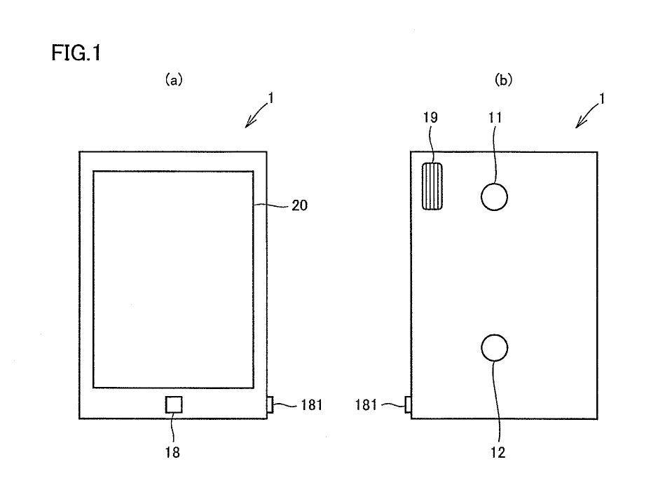

FIG. 1 shows an external appearance of a mobile phone 1. FIG. 1(a) is a front view of mobile phone 1. FIG. 1(b) is rear view of mobile phone 1. Referring to FIG. 1(a), mobile phone 1 includes a display 20, and an operation button 18 including a shutter button 181. It should be noted that while not in a mode for performing image capturing, shutter button 181 may function as a button for instructing execution of a process other than the image capturing. Referring to FIG. 1(b), mobile phone 1 includes a camera 11, a camera 12, and a flashlight 19 in its surface opposite to the surface provided with display 20.

Mobile phone 1 generates an image that looks stereoscopic for an observer (hereinafter, referred to as “stereoscopic image” or “3D image”) based on an image captured by camera 11 (hereinafter, also referred to as “left-eye image”) and an image captured by camera 12 (hereinafter, also referred to as “right-eye image”). It should be noted that in order to obtain a 3D image, image capturing by camera 11 and image capturing by camera 12 are simultaneously performed.

<Overview of Data Process by Mobile Phone>

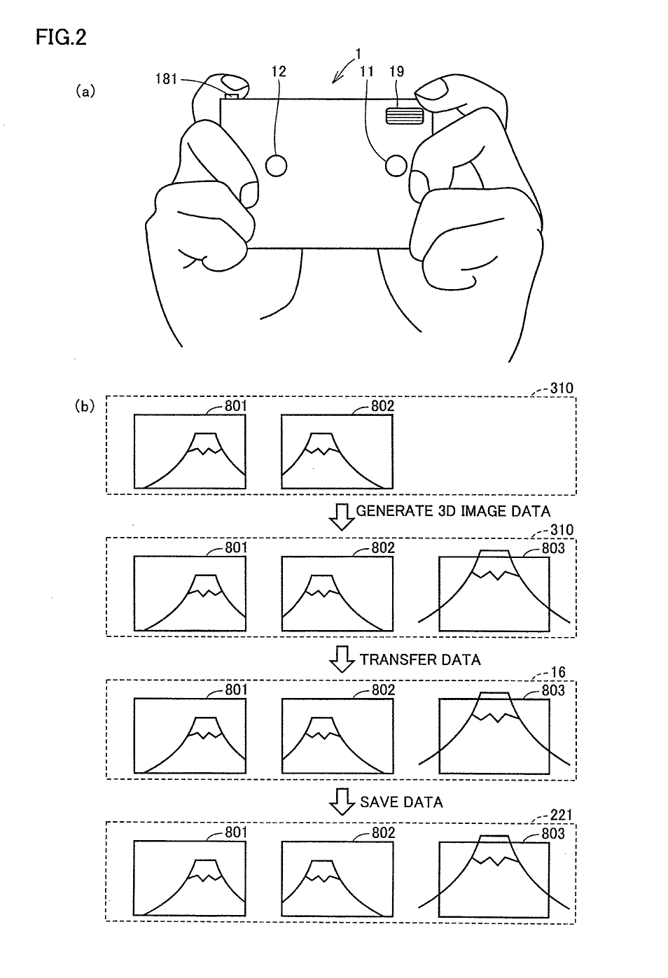

FIG. 2 illustrates a first example of data processes performed by mobile phone 1 when capturing images of a target using two cameras 11, 12. FIG. 2(a) shows that a user of mobile phone 1 holds mobile phone 1 by both hands for the purpose of image capturing of a target. FIG. 2(b) shows the data processes in a time series manner when shutter button 181 is pressed down during the state of FIG. 2(a).

Referring to FIG. 2(a), no fingers of the user's right hand and left hand are over camera 11 and camera 12. Hence, no fingers are captured in the left-eye image and the right-eye image.

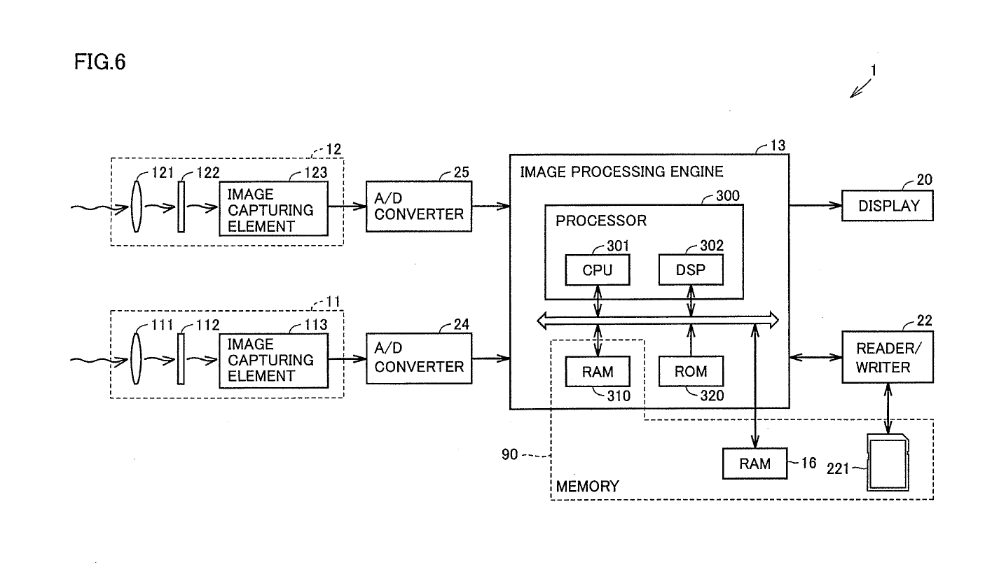

Referring to FIG. 2(b), left-eye image data 801 obtained through the image capturing employing camera 11 and right-eye image data 802 obtained through the image capturing employing camera 12 are stored in a RAM 310 (see FIG. 6) provided in an image processing engine 13 described below. In mobile phone 1, 3D image data 803 is generated by image processing engine 13 based on left-eye image data 801 and right-eye image data 802.

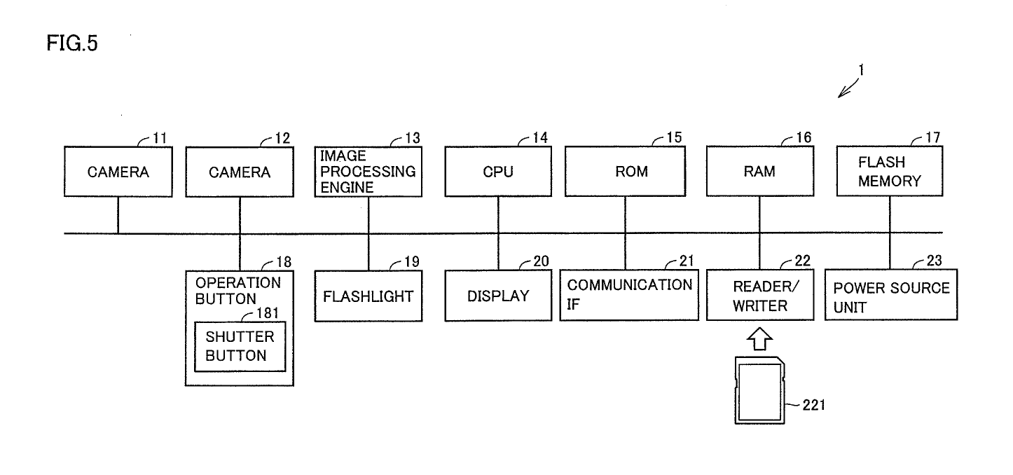

Mobile phone 1 transfers left-eye image data 801, right-eye image data 802, and 3D image data 803 to a RAM (Random Access Memory) 16 (see FIG. 5 and FIG. 6) provided external to image processing engine 13. Further, mobile phone 1 writes, in an IC (Integrated Circuit) recording medium 221 (see FIG. 5 and FIG. 6), image data 801, 802, 803 stored in RAM 16, when receiving the user's instruction for data saving. Alternatively, mobile phone 1 automatically writes them therein without such an instruction.

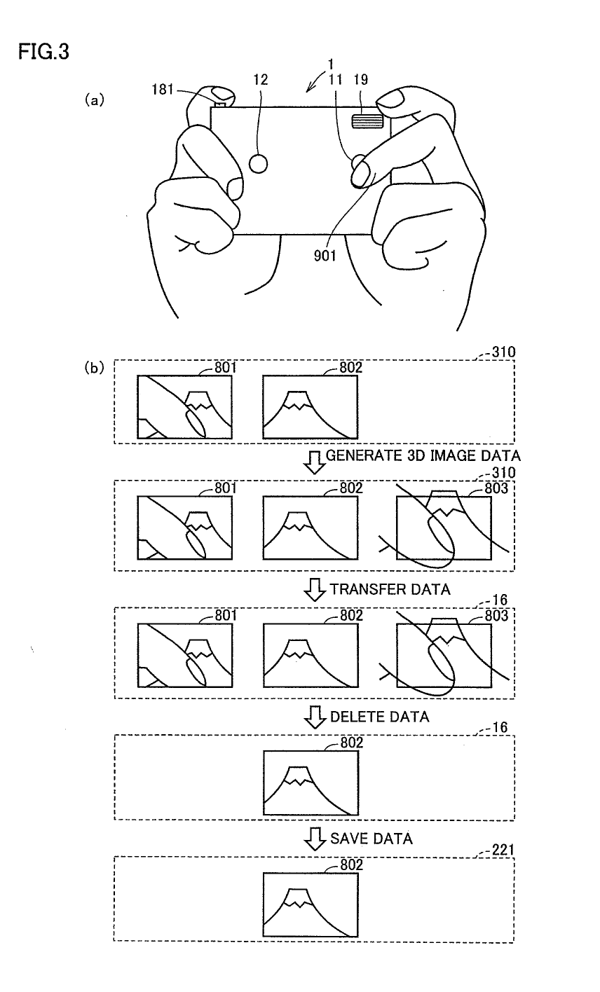

FIG. 3 illustrates a second example of data processes performed by mobile phone 1 when capturing images of a target using two cameras 11, 12. FIG. 3(a) shows that the user of mobile phone 1 holds mobile phone 1 by both hands for the purpose of image capturing of a target, and that middle finger 901 of the left hand is over a portion of the lens of camera 11. FIG. 3(b) shows the data processes in a time series manner when shutter button 181 is pressed down during the state of FIG. 3(a).

Referring to FIG. 3(a), middle finger 901 of the user's left hand is over camera 11, so that middle finger 901 is captured in the left-eye image.

Referring to FIG. 3(b), left-eye image data 801 obtained through the image capturing employing camera 11 and right-eye image data 802 obtained through the image capturing employing camera 12 are stored in RAM 310 provided in image processing engine 13. In this case, left-eye image data 801 includes image data indicating middle finger 901.

In mobile phone 1, 3D image data 803 is generated by image processing engine 13 based on left-eye image data 801 and right-eye image data 802. In this case, the image data indicating middle finger 901 is also included in 3D image data 803. Mobile phone 1 transfers left-eye image data 801, right-eye image data 802, and 3D image data 803 to RAM 16 provided external to image processing engine 13.

Mobile phone 1 deletes left-eye image data 801, which has middle finger 901 captured therein, from RAM 16. Also from RAM 16, mobile phone 1 deletes 3D image data 803 generated using left-eye image data 801 having middle finger 901 captured therein.

Further, mobile phone 1 writes, in IC recording medium 221, only right-eye image data 802 not deleted and remaining in RAM 16, when receiving the user's instruction for data saving. Alternatively, mobile phone 1 automatically writes it therein.

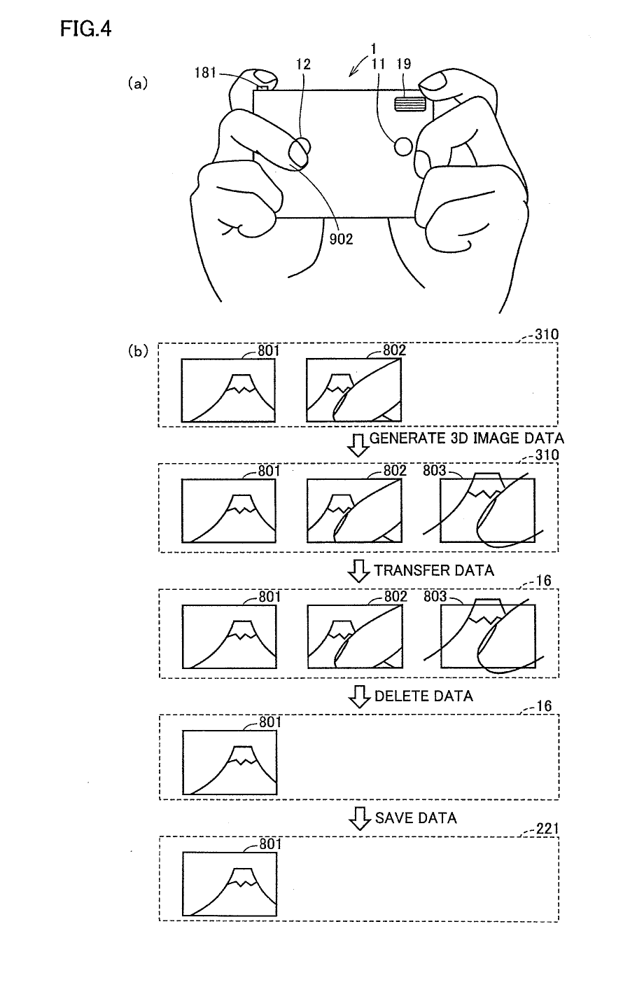

FIG. 4 illustrates a third example of data processes performed by mobile phone 1 when capturing images of a target using two cameras 11, 12. FIG. 4(a) shows that the user of mobile phone 1 holds mobile phone 1 by both hands for the purpose of image capturing of a target, and that middle finger 902 of the right hand is over a portion of the lens of camera 12. FIG. 4(b) shows the data processes in a time series manner when shutter button 181 is pressed down during the state of FIG. 4(a).

Referring to FIG. 4(a), middle finger 902 of the user's right hand is over camera 12, so that middle finger 902 is captured in the right-eye image.

Referring to FIG. 4(b), left-eye image data 801 obtained through the image capturing employing camera 11 and right-eye image data 802 obtained through the image capturing employing camera 12 are stored in RAM 310 provided in image processing engine 13. In this case, right-eye image data 802 includes image data indicating middle finger 902.

In mobile phone 1, 3D image data 803 is generated by image processing engine 13 based on left-eye image data 801 and right-eye image data 802. In this case, the image data indicating middle finger 902 is also included in 3D image data 803.

Mobile phone 1 transfers left-eye image data 801, right-eye image data 802, and 3D image data 803 to RAM 16 provided external to image processing engine 13.

Mobile phone 1 deletes right-eye image data 802, which has middle finger 902 captured therein, from RAM 16. Also from RAM 16, mobile phone 1 deletes 3D image data 803 generated using right-eye image data 802 having middle finger 902 captured therein.

Further, mobile phone 1 writes, in IC recording medium 221, only left-eye image data 801 not deleted and remaining in RAM 16, when receiving the user's instruction for data saving. Alternatively, mobile phone 1 automatically writes it therein.

As described above, from RAM 16, mobile phone 1 deletes the image data having middle finger 901 or middle finger 902 captured therein, and also deletes 3D image data 803 generated based on this image data. After deleting these image data, mobile phone 1 saves, in IC recording medium 221 attachable/detachable to/from mobile phone 1, the image data not deleted and remaining in RAM 16.

Thus, according to mobile phone 1, only the image data not having the finger captured therein can be saved in IC recording medium 221. Namely, from left-eye image data 801 and right-eye image data 802, only the image data considered as being satisfactory for the user can be saved in IC recording medium 221 without saving the image data considered as being unsatisfactory. In this way, the image data considered as being unsatisfactory for the user can be prevented from being stored in IC recording medium 221. Thus, the use of mobile phone 1 enables efficient utilization of the storage area of IC recording medium 221.

Meanwhile, 3D image data 803 generated based on the image data having the finger captured therein is image data considered as being unsatisfactory for the user. Hence, mobile phone 1 does not save this 3D image data 803 in IC recording medium 221, thereby enabling more efficient utilization of the storage area of IC recording medium 221.

In the case of FIG. 3, mobile phone 1 may be configured to delete left-eye image data 801 and 3D image data 803 from RAM 16 after saving right-eye image data 802 in IC recording medium 221. Likewise, in the case of FIG. 4, mobile phone 1 may be configured to delete right-eye image data 802 and 3D image data 803 from RAM 16 after saving left-eye image data 801 in IC recording medium 221.

The following describes a specific configuration of mobile phone 1 for implementing such data processes.

<Hardware Configuration>

FIG. 5 shows a hardware configuration of mobile phone 1. Referring to FIG. 5, mobile phone 1 includes: camera 11; camera 12; image processing engine 13; a CPU (Central Processing Unit) 14 for executing a program; ROM (Read Only Memory) 15 having data stored therein in a nonvolatile manner; RAM 16 having data stored therein in a volatile manner; a NAND type flash memory 17; operation button 18 for receiving an instruction input from the user of mobile phone 1; flashlight 19; display 20; a communication IF (Interface) 21; a reader/writer 22; and a power source unit 23.

Image processing engine 13 generates image data based on electric charge generated when an image capturing element included in each of cameras 11, 12 is irradiated with light. Details of image processing engine 13 will be described later.

CPU 14 performs data processes other than the data processes performed by image processing engine 13.

Flash memory 17 is a nonvolatile semiconductor memory. Flash memory 17 stores, in a volatile manner, various type of programs for controlling mobile phone 1 as well as various types of data such as data generated by mobile phone 1 and data obtained from a device external to mobile phone 1.

Communication IF 21 performs signal processing to allow mobile phone 1 to wirelessly communicate with an external communication device. Power source unit 23 supplies electric power to cameras 11, 12, image processing engine 13, CPU 14, flashlight 19, display 20, communication IF 21, reader/writer 22, and the like via a data bus.

Components 11 to 23 are connected to one another via the data bus. IC recording medium 221 is attached to reader/writer 22.

The processes in mobile phone 1 are implemented by each hardware and software executed by image processing engine 13 and CPU 14. Such software may be stored in image processing engine 13 and flash memory 17 in advance. Alternatively, the software may be stored in IC recording medium 221 or another storage medium and may be distributed as a program product. Alternatively, the software may be provided as a downloadable program product by an information provider connected to the Internet. Such software is read from the storage medium by reader/writer 22 or another reading device or is downloaded via the communication IF, and is thereafter temporarily stored in flash memory 17. The software is read from flash memory 17 by CPU 14, and is stored in flash memory 17 or image processing engine 13 in the form of an executable program. Image processing engine 13 or CPU 14 executes the program.

The components included in mobile phone 1 shown in the figure are general ones. Therefore, it can be said that an essential portion of the present invention lies in the software stored in image processing engine 13, flash memory 17, IC recording medium 221, or another storage medium, or lies in the software downloadable via a network. It should be noted that operations of the hardware of mobile phone 1 are well known and therefore are not repeatedly described in detail.

The recording medium is not limited to the IC card, and may be any medium holding a program in a fixed manner such as a DVD-ROM, a CD-ROM, an FD (Flexible Disk), a hard disk, a magnetic tape, a cassette tape, an optical disk (MO (Magnetic Optical Disc)/MD (Mini Disc)/DVD (Digital Versatile Disc)), an optical card, and a semiconductor memory such as a mask ROM, an EPROM (Electronically Programmable Read-Only Memory), an EEPROM (Electronically Erasable Programmable Read-Only Memory), and a flash ROM. Further, the recording medium is a non-transitory medium from which a computer can read the program or the like.

Here, the term “program” is intended to include not only a program directly executable by the CPU but also a program in the form of source program, a compressed program, an encrypted program, and the like.

FIG. 6 shows main portions of the hardware configuration of mobile phone 1. Referring to FIG. 6, mobile phone 1 includes camera 11, camera 12, image processing engine 13, RAM 16, display 20, reader/writer 22, an A/D (Analog/Digital) converter 24, and an A/D converter 25. IC recording medium 221 is attached to reader/writer 22.

Camera 11 includes a lens 111, a mechanical shutter 112, and image capturing element 113. Camera 12 includes a lens 121, a mechanical shutter 122, and image capturing element 123.

Lens 111 collects external light (light reflected by the target of image capturing). Mechanical shutter 112 is a device for switching as to whether to irradiate image capturing element 113 with the light having passed through lens 111. Mechanical shutter 112 operates in response to pressing down of shutter button 181. More specifically, mechanical shutter 112 operates based on an instruction of CPU 14. Image capturing element 113 converts the light into an electric signal. Further, image capturing element 113 sends the electric signal to A/D converter 24. Image capturing element 113 is a CCD (Charge Coupled Device) or a CMOS (Charge Coupled Device), for example.

Lens 121 collects external light (light reflected by the target of image capturing). Mechanical shutter 122 is a device for switching as to whether to irradiate image capturing element 123 with the light having passed through lens 121. Mechanical shutter 122 operates in response to pressing down of shutter button 181. More specifically, mechanical shutter 122 operates based on an instruction of CPU 14. Image capturing element 123 converts the light into an electric signal. Further, image capturing element 123 sends the electric signal to A/D converter 25. Image capturing element 123 is also the same type of element as image capturing element 113.

A/D converter 24 converts an analog signal output by image capturing element 113, into a digital signal. A/D converter 24 sends the digital signal thus obtained by the conversion, to image processing engine 13.

A/D converter 25 converts an analog signal output by image capturing element 123, into a digital signal. A/D converter 25 sends the digital signal thus obtained by the conversion, to image processing engine 13.

The following describes image processing engine 13. Image processing engine 13 includes a processor 300, a RAM 310, and a ROM 320. Processor 300 includes a CPU 301, and a DSP (Digital Signal Processor) 302. CPU 301, DSP 302, RAM 310, and ROM 320 are connected to one another via a data bus.

Processor 300 performs a process based on a program stored in ROM 320. CPU 301 performs processes regarding general control and communication in image processing engine 13. CPU 301 is a CPU with an RISC (Reduced Instruction Set Computer) architecture, for example. DSP 302 is a processor only for image processing. It should be noted that the number of DSPs 302 included in processor 300 is not limited to one.

RAM 310 serves as a buffer memory, which temporarily stores digital signals sent from A/D converters 24, 25. Also, RAM 310 serves as a work memory during data processes performed by CPU 301 and DSP 302. ROM 320 includes a program to be executed by processor 300.

CPU 301 writes data in RAMs 310, 16, reads data from RAMs 310, 16, and deletes data recorded in RAMs 310, 16. Moreover, CPU 301 controls writing of data in IC recording medium 221, reading of data from IC recording medium 221, and deletion of data from IC recording medium 221.

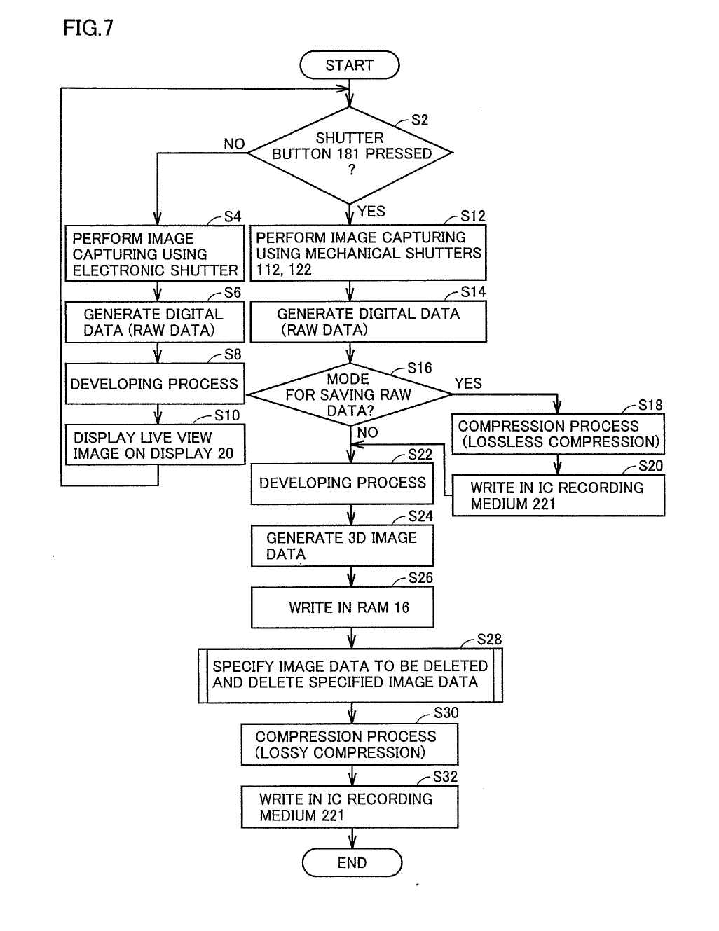

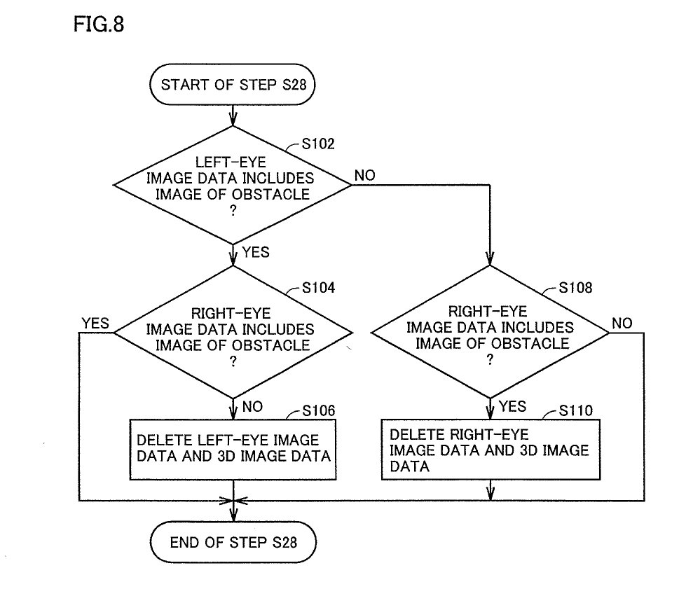

It should be noted that other processes performed by image processing engine 13 will be described later (FIG. 7 and FIG. 8). Further, in the description below, a configuration including RAM 310, RAM 16, and IC recording medium 221 will be referred to as “memory 90”.

<Control Structure>

FIG. 7 is a flowchart showing a flow of processes performed in mobile phone 1. Specifically, FIG. 7 shows a flow of data processes when an operation mode of mobile phone 1 is switched to the image capturing mode.

Referring to FIG. 7, in a step S2, CPU 14 determines whether or not shutter button 181 has been pressed by the user. Here, the expression “shutter button 181 has been pressed down” is intended to exclude pressing down shutter button 181 halfway for the purpose of attaining focus by an automatic focusing function.

When CPU 301 of image processing engine 13 receives an indication from CPU 14 such that shutter button 181 has not been pushed down (NO in step S2), CPU 301 performs image capturing of a target using an electronic shutter. It should be noted that the electronic shutter is a shutter implemented by image processing engine 13 and no physical light shielding plate is required.

When performing the image capturing employing the electronic shutter, CPU 301 brings mechanical shutter 112 into an open state and brings mechanical shutter 122 into a closed state, for example. CPU 301 receives a digital signal that is based on an analog signal output by image capturing element 113. It should be noted that both mechanical shutters 112, 122 may be brought into the open state.

In a step S4, CPU 301 generates digital data (hereinafter, referred to as “RAW data”). In a step S6, CPU 301 performs a developing process for the RAW data generated. With this developing process, the RAW data becomes visible image data, which can be recognized as an image by eyes of human being. In a step S10, CPU 301 displays a live view image on display 20. Accordingly, the user can view and recognize an image of the target of the image capturing employing the electronic shutter, in real-time on display 20.

When CPU 301 receives an indication from CPU 14 such that shutter button 181 has been pushed down (YES in step S2), CPU 301 performs image capturing of the target using two mechanical shutters 112, 122 in a step S12. In a step S14, CPU 301 generates RAW data based on digital signals respectively output from A/D converters 24, 25. In other words, CPU 301 generates two pieces of RAW data.

In a step S16, CPU 301 determines whether or not a mode for saving RAW data is set in a detailed setting of the image capturing mode. In the case where mobile phone 1 does not have a function of saving the RAW data, this determination is not performed and CPU 301 proceeds the process to a step S22.

When CPU 301 determines that the mode for saving the RAW data is set (YES in step S16), CPU 301 compresses the RAW data in a step S18. Specifically, CPU 301 losslessly compresses the RAW data. In a step S20, CPU 301 writes the losslessly compressed RAW data in IC recording medium 221, and thereafter proceeds the process to a step S22.

When CPU 301 determines that the mode for saving the RAW data is not set (NO in step S16), CPU 301 performs a developing process in a step S22. Specifically, CPU 301 performs a sensor compensation process, a de-mosaicing process, a pixel interpolation process, a color correction process (white balance adjustment, color matrix conversion, or gamma conversion), and an RGB image process (sharpness correction, tone correction, exposure correction, or the like).

As a result of the process in step S22, left-eye image data 801 and right-eye image data 802 such as those shown in FIG. 2 to FIG. 4 are stored in RAM 310 of image processing engine 13, for example. In a step S24, CPU 301 generates 3D image data using the left-eye image data and right-eye image data obtained in the developing process of step S22. CPU 301 stores the generated 3D image data in RAM 310.

In a step S26, CPU 301 writes, in RAM 16, the left-eye image data and right-eye image data obtained in the developing process of step S22, as well as the 3D image data obtained in the process of step S24. Specifically, CPU 301 correlates the left-eye image data, the right-eye image data, and the 3D image data with one another and transfers them to RAM 16.

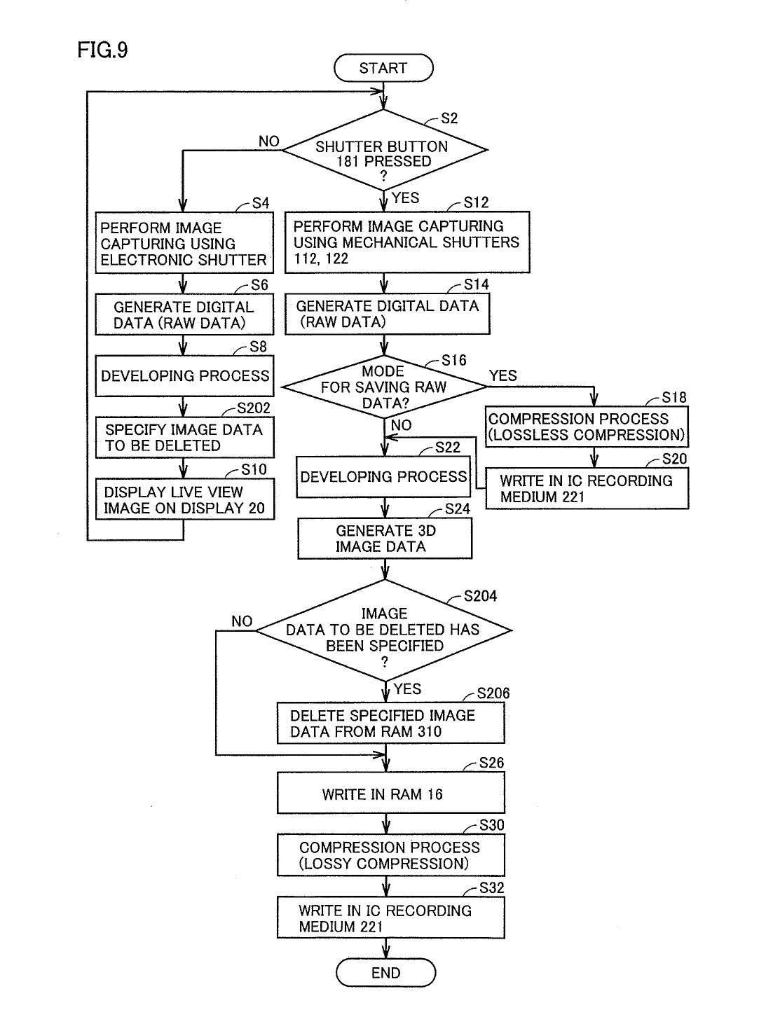

In a step S28, among the left-eye image data, the right-eye image data, and the 3D image data, CPU 301 specifies image data to be deleted from RAM 16, and deletes the specified image data from RAM 16. Details of the process in step S28 will be described later (FIG. 9).

In a step S30, CPU 301 compresses the image data not deleted from RAM 16 among the left-eye image data, the right-eye image data, and the 3D image data. Specifically, CPU 301 performs lossy compression of the image data not deleted from RAM 16. For example, CPU 301 converts the image data not deleted from RAM 16, into image data of a predetermined format (JPEG format, DCF format, Exif format, or TIFF format). In a step S32, CPU 301 writes, in IC recording medium 221, the image data compressed in step S30.

In this way, CPU 301 ends the series of processes.

It should be noted that the order of the data processes performed by CPU 301 is not limited to the order shown in FIG. 7. For example, CPU 301 may perform the process of step S18 and the process of step S20 in parallel with the processes of step S22 to step S32. Further, the image data to be deleted from RAM 16 may be deleted after ending the writing of the image data in IC recording medium 221 as shown in step S32. Further, the order of the process of step S28 and the order of the process of step S30 may be replaced with each other. Further, the process in which the left-eye image data and right-eye image data obtained in step S22 are stored in RAM 16 may be performed before generating the 3D image data in step S24.

FIG. 8 is a flowchart showing details of the process in step S28 of FIG. 7. Referring to FIG. 8, in a step S102, CPU 301 determines whether or not the left-eye image data includes an image of an object (hereinafter, also referred to as “obstacle”) that blocks entrance of external light into image capturing element 113. An example of such an obstacle is a finger or the like. For this determination, the art illustrated as the background art can be employed, for example. Alternatively, CPU 301 may determine that the left-eye image data includes an image of an obstacle, when a region having a brightness not more than a threshold value exists over a predetermined width in the left-eye image that is based on the left-eye image data. Alternatively, CPU 301 may determine that the left-eye image data includes an image of an obstacle, when a region having a brightness not more than a threshold value exists over a predetermined width in the left-eye image that is based on the left-eye image data and when a region having a brightness not more than a threshold value does not exist over the predetermined width in the right-eye image that is based on the right-eye image data. The method of determination as to the inclusion of the image of the obstacle is not particularly limited.

In the case where CPU 301 determines that the left-eye image data includes an image of an obstacle (YES in step S102), CPU 301 determines in a step S104 whether or not the right-eye image data includes an image of an obstacle that blocks entrance of external light into image capturing element 123. For this determination, the art illustrated as the background art can be employed, for example. Alternatively, CPU 301 may determine that the right-eye image data includes an image of an obstacle, when a region having a brightness not more than a threshold value exists over a predetermined width in the right-eye image. Alternatively, CPU 301 may determine that the right-eye image data includes an image of an obstacle, when a region having a brightness not more than a threshold value exists over a predetermined width in the right-eye image and when a region having a brightness not more than a threshold value does not exist over a predetermined width in the left-eye image. The method of determination as to the inclusion of the image of the obstacle is not particularly limited.

When CPU 301 determines that the right-eye image data includes an image of an obstacle (YES in step S104), CPU 301 ends the series of processes. In other words, CPU 301 deletes none of the left-eye image data, the right-eye image data, and the 3D image data from RAM 16. On the other hand, when CPU 301 determines that the right-eye image data does not include an image of an obstacle (NO in step S104), CPU 301 deletes the left-eye image data and the 3D image data from RAM 16 in a step S106.

When CPU 301 determines that the left-eye image data does not include an image of an obstacle (NO in step 102), CPU 301 determines in a step S108 whether or not the right-eye image data includes an image of an obstacle. When CPU 301 determines that the right-eye image data does not include an image of an obstacle (NO in step 108), CPU 301 ends the series of processes. In other words, CPU 301 deletes none of the left-eye image data, the right-eye image data, and the 3D image data from RAM 16. On the other hand, when CPU 301 determines that the right-eye image data includes an image of an obstacle (YES in step 108), CPU 301 deletes the right-eye image data and the 3D image data from RAM 16 in a step S110.

As described above, CPU 301 determines whether or not each of the left-eye image data and right-eye image data captured using mechanical shutters 112, 122 satisfies such a condition that no image of an obstacle such as a finger is included therein. When CPU 301 determines that one of the left-eye image data and the right-eye image data does not satisfy the condition, CPU 301 deletes the one of the left-eye image data and the right-eye image data from RAM 16. Moreover, when CPU 301 determines that one of the left-eye image data and the right-eye image data does not satisfy the condition, CPU 301 deletes the 3D image data, which has been generated based on the left-eye image data and the right-eye image data, from RAM 16.

<Modification>

(1) The description above has illustrated the configuration in which the left-eye image data and the right-eye image data are not deleted when an image of an obstacle is included in each of the left-eye image data and the right-eye image data, the present invention is not limited to this. For example, mobile phone 1 may be configured to delete the left-eye image data and the right-eye image data when an image of an obstacle is included in each of the left-eye image data and the right-eye image data.

(2) Meanwhile, mobile phone 1 may be configured not to generate the 3D image data when an image of an obstacle is included in the left-eye image data or the right-eye image data. Moreover, mobile phone 1 may be configured not to generate the 3D image data when an image of an obstacle is included in each of the left-eye image data and the right-eye image data.

(3) The description above has illustrated the configuration in which the image data to be deleted is specified after performing image capturing using mechanical shutters 112, 122 as shown in FIG. 7. More specifically, the above description has illustrated the configuration in which the data to be deleted is specified after writing the left-eye image data, the right-eye image data, and the 3D image data in RAM 16.

The following describes a configuration in which image data to be deleted is specified before performing image capturing using mechanical shutters 112, 122 and after performing image capturing using the electronic shutter. Specifically, the following describes a configuration in which any of the data is deleted before the left-eye image data and right-eye image data obtained using mechanical shutters 112, 122 are written in RAM 16.

FIG. 9 is a flowchart showing another flow of the processes performed in mobile phone 1. Specifically, FIG. 9 is a flowchart showing another flow of the processes in the case where image data to be deleted is specified before performing image capturing using mechanical shutters 112, 122 and after performing image capturing using the electronic shutter.

Referring to FIG. 9, the flowchart of FIG. 9 is different from the flowchart of FIG. 7 in that a process of a step S202 is performed between the process of step S8 and the process of step S10. Also, the flowchart of FIG. 9 is different from the flowchart of FIG. 7 in that instead of the process of step S28, a step S204 and a step S206 are provided between the process of step S24 and the process of step S26. Hence, the differences from the flowchart of FIG. 7 will be mainly described below.

In the description below, it is assumed that mobile phone 1 brings both mechanical shutters 112, 122 into the open state when performing image capturing using the electronic shutter. Moreover, it is assumed that mobile phone 1 has an automatic focusing function.

In step S202, CPU 301 specifies image data to be deleted, using the left-eye image data and right-eye image data captured using the electronic shutter. Specifically, CPU 301 performs the following process.

First, it is determined whether or not each of the left-eye image data and right-eye image data captured using the electronic shutter includes an image of an obstacle such as a finger. More specifically, CPU 301 determines whether or not an image of an obstacle such as a finger is included in each of the left-eye image data and right-eye image data captured using the electronic shutter with focus being attained by the automatic focusing function. As a specific example, CPU 301 determines whether or not an image of an obstacle is included when it is determined that focus is attained by pressing down shutter button 181 halfway. CPU 301 specifies a camera that has provided image processing engine 13 with the image data including the image of the obstacle such as a finger.

Next, when CPU 301 specifies that camera 11 has provided image processing engine 13 with the left-eye image data including the image of the obstacle, CPU 301 specifies the left-eye image data captured using mechanical shutter 112, as the image data to be deleted. On the other hand, when CPU 301 specifies that camera 12 has provided image processing engine 13 with the right-eye image data including the image of the obstacle, CPU 301 specifies the right-eye image data captured using mechanical shutter 122, as the image data to be deleted. In these cases, the 3D image data to be generated based on the left-eye image data and the right-eye image data captured using mechanical shutters 112, 122 is also specified as the data to be deleted. Data indicating the data specified to be deleted is stored in RAM 310.

It should be noted that when CPU 301 does not specify each of camera 11 and camera 12 as a camera that has provided image processing engine 13 with the image data including the image of the obstacle, the left-eye image data, the right-eye image data, and the 3D image data are not to be deleted.

In step S204, CPU 301 determines whether or not the image data to be deleted has been specified. When CPU 301 determines that the image data to be deleted has been specified (YES in step S204), CPU 301 deletes in step S206 the specified image data from RAM 310 of image processing engine 13. When the image to be deleted has not been specified (NO in step S204), CPU 301 proceeds the process to step S30.

Thus, when shutter button 181 is pressed down (i.e., image capturing using mechanical shutters 112, 122 is performed) in the case where CPU 301 has determined that one of the left-eye image data and the right-eye image data includes the image of the obstacle, CPU 301 deletes, from RAM 310, the previously specified one of the image data obtained through the image capturing using mechanical shutters 112, 122.

In this case, the image data not deleted from RAM 310 among the left-eye image data, the right-eye image data, and the 3D image data is written in RAM 16 in step S26. It should be noted that the 3D image data may be generated after writing the left-eye image data and the right-eye image data in RAM 16.

As described above, CPU 301 determines whether or not the image of the obstacle is included in each of the left-eye image data and right-eye image data obtained through image capturing employing the electronic shutter. When shutter button 181 is pressed down in the case where CPU 301 has determined that the image of the object is included only in the left-eye image data obtained through the image capturing employing the electronic shutter, CPU 301 deletes, from RAM 310, the left-eye image data obtained through the image capturing employing mechanical shutter 112. When shutter button 181 is pressed down in the case where CPU 301 deteimines that the image of the obstacle is included only in the right-eye image data obtained through the image capturing employing the electronic shutter, CPU 301 deletes, from RAM 310, the right-eye image data obtained through the image capturing employing mechanical shutter 122.

Further, in the description above, it has been illustrated that the image data specified to be deleted is deleted from RAM 310, but the present invention is not limited to this. Mobile phone 1 may be configured such that CPU 301 writes, in RAM 16, the left-eye image data and right-eye image data stored in RAM 310, and thereafter deletes the left-eye image data or right-eye image data specified to be deleted from RAM 16. CPU 301 may delete the 3D image data when it is stored in RAM 16.

Further, the image data for which it is determined whether or not the obstacle is included may be image data obtained using the electronic shutter by a predetermined time before pressing down shutter button 181 to operate mechanical shutters 112, 122.

(4) In the description above, it has been illustrated that among the left-eye image data, the right-eye image data, and the 3D image data, CPU 301 deletes the image data specified to be deleted from RAM 16 or RAM 310, but the present invention is not limited to this.

For example, mobile phone 1 may be configured such that CPU 301 deletes the image data to be deleted from IC recording medium 221, after writing the left-eye image data, the right-eye image data, and the 3D image data in IC recording medium 221. It should be noted that IC recording medium 221 can be also referred to as an “external storage memory” and each of RAMs 310, 16 can be referred to as an “internal storage memory”.

Thus, in mobile phone 1, the timing of deletion of the image data to be deleted is not particularly limited.

Further, when deleting one of the left-eye image data and the right-eye image data, the 3D image data may not be generated or the 3D image data may be generated and then deleted. In other words, whether to generate the 3D image data is not particularly limited.

### CONCLUSION

Mobile phone 1 is an image capturing device of a compound eye type for generating stereoscopic image data for displaying a stereoscopic image, based on the left-eye image data and right-eye image data obtained through the image capturing. Mobile phone 1 includes: image capturing element 113 for generating the left-eye image data; image capturing element 123 for generating the right-eye image data; CPU 301; and memory 90 for storing the left-eye image data, the right-eye image data, and the stereoscopic image data therein. CPU 301 determines whether or not the left-eye image data includes an image of an obstacle that blocks entrance of external light into image capturing element 113, and determines whether or not the right-eye image data includes an image of an obstacle that blocks entrance of external light into image capturing element 123. When one of the left-eye image data and the right-eye image data includes the image of the obstacle and the other of the left-eye image data and the right-eye image data does not include the image of the obstacle, CPU 301 deletes the image data including the image of the obstacle from memory 90.

Hence, according to mobile phone 1 described above, only the image data having no obstacle captured therein can be saved in IC recording medium 221, or can be maintained in the IC recording medium. Namely, from left-eye image data 801 and right-eye image data 802, only the image data considered as being satisfactory for the user can be saved in or can be maintained in IC recording medium 221 without saving or maintaining the image data considered as being unsatisfactory. In this way, the image data considered as being unsatisfactory for the user can be prevented from being stored or being maintained in IC recording medium 221. Thus, the use of mobile phone 1 enables efficient utilization of the storage area of IC recording medium 221.

The embodiments disclosed herein are illustrative and are not limited only to the above description. The scope of the present invention is defined by the terms of the claims, and is intended to include any modifications within the scope and meaning equivalent to the terms of the claims.

### REFERENCE SIGNS LIST

1: mobile phone; 11, 12: camera; 13: image processing engine; 14, 301: CPU; 16, 310: RAM; 17: flash memory; 18: operation button; 19: flashlight; 20: display; 22: reader/writer; 23: power source unit; 90: memory; 111, 121: lens; 112, 122: mechanical shutter; 113, 123: image capturing element; 181: shutter button; 221: IC recording medium; 300: processor; 302: DSP; 320: ROM; 801: left-eye image data; 802: right-eye image data; 803: 3D image data; 901, 902: middle finger.

1. An image capturing device of a compound eye type for generating stereoscopic image data for displaying a stereoscopic image, based on left-eye image data and right-eye image data obtained through image capturing, comprising:
a first image capturing element for generating said left-eye image data;
a second image capturing element for generating said right-eye image data;
a processor; and
a memory for storing said left-eye image data, said right-eye image data, and said stereoscopic image data therein,
said processor determining whether or not said left-eye image data includes an image of an object that blocks entrance of external light into said first image capturing element,
said processor determining whether or not said right-eye image data includes an image of an object that blocks entrance of external light into said second image capturing element,
when one of said left-eye image data and said right-eye image data includes said image of said object and the other of said left-eye image data and said right-eye image data does not include said image of said object, said processor deleting said one of said left-eye image data and said right-eye image data from said memory.

2. The image capturing device according to claim 1, wherein when said processor deletes said one of said left-eye image data and said right-eye image data from said memory, said processor further deletes, from said memory, said stereoscopic image data generated based on said left-eye image data and said right-eye image data.

3. The image capturing device according to claim 1, further comprising:
a shutter button; and
a mechanical shutter, which is operated in response to pressing down of said shutter button, wherein
said processor determines whether or not each of said left-eye image data and said right-eye image data obtained through the image capturing employing said mechanical shutter includes said image of said object,
when said processor determines that said image of said object is included only in said left-eye image data obtained through the image capturing employing said mechanical shutter, said processor deletes said left-eye image data from said memory, and
when said processor determines that said image of said object is included only in said right-eye image data obtained through the image capturing employing said mechanical shutter, said processor deletes said right-eye image data from said memory.

4. The image capturing device according to claim 1, further comprising:
a display;
an electronic shutter for displaying a live view image on said display;
a shutter button; and
a mechanical shutter, which is operated in response to pressing down of said shutter button, wherein
said processor determines whether or not each of said left-eye image data and said right-eye image data obtained through the image capturing employing said electronic shutter includes said image of said object,
when said shutter button is pressed down in a case where said processor determines that said image of said object is included only in said left-eye image data obtained through the image capturing employing said electronic shutter, said processor deletes, from said memory, said left-eye image data obtained through the image capturing employing said mechanical shutter, and
when said shutter button is pressed down in a case where the processor determines that said image of said object is included only in said right-eye image data obtained through the image capturing employing said electronic shutter, said processor deletes, from said memory, said right-eye image data obtained through the image capturing employing said mechanical shutter.

5. The image capturing device according to claim 4, wherein
the image capturing device has an automatic focusing function, and
said processor determines whether or not said image of said object is included in each of said left-eye image data and said right-eye image data obtained through the image capturing employing said electronic shutter with focus being attained by said automatic focusing function, using said left-eye image data and said right-eye image data.

6. The image capturing device according to claim 1, wherein
said memory includes a volatile memory and a nonvolatile memory,
said processor stores said left-eye image data and said right-eye image data in said volatile memory, and
when said processor determines that one of said left-eye image data and said right-eye image data includes said image of said object and the other of said left-eye image data and said right-eye image data does not include said image of said object, said processor deletes said one of said left-eye image data and said right-eye image data from said volatile memory, and stores the other of said left-eye image data and said right-eye image data in said nonvolatile memory.

7. The image capturing device according to claim 6, wherein said nonvolatile memory is a recording medium attachable/detachable to/from said image capturing device.

8. A data processing method in an image capturing device of a compound eye type for generating stereoscopic image data for displaying a stereoscopic image, based on left-eye image data and right-eye image data obtained through image capturing, the image capturing device including a first image capturing element for generating said left-eye image data, a second image capturing element for generating said right-eye image data, a processor, and a memory for storing said left-eye image data, said right-eye image data, and said stereoscopic image data therein,
the data processing method comprising the steps of:
determining, by said processor, whether or not said left-eye image data includes an image of an object that blocks entrance of external light into said first image capturing element;
determining, by said processor, whether or not said right-eye image data includes an image of an object that blocks entrance of external light into said second image capturing element; and
when one of said left-eye image data and said right-eye image data includes said image of said object and the other of said left-eye image data and said right-eye image data does not include said image of said object, said processor deleting said one of said left-eye image data and said right-eye image data from said memory.

9. (canceled)
